(19) United States
(12) Patent Application Publication
(10) Pub. No.: US 2011/0236853 A1
(43) Pub. Date: Sep. 29, 2011

(54) DENTAL DRILL EXTENSION

(75) Inventor: Yoshiaki Shimoo, Tokyo (JP)

(73) Assignee: Klad Corporation, Yokohama-shi (JP)

(21) Appl. No.: 13/071,471

(22) Filed: Mar. 24, 2011

Related U.S. Application Data
(60) Provisional application No. 61/340,997, filed on Mar. 25, 2010.

(51) Int. Cl. A61C 3/02; A61C 17/02

(52) U.S. Cl. 433/82; 433/165; 433/126

(57) ABSTRACT

An extender for a dental apparatus comprises a distal connecting portion, a proximal connecting portion, and an elongated portion disposed between the distal connecting portion and the proximal connecting portion, wherein the distal connecting portion is configured to connect to a dental drill bit or the proximal connecting portion and wherein the proximal connecting portion is configured to connect to a dental hand piece or the distal connecting portion.

### CROSS-REFERENCES TO RELATED APPLICATIONS

This application claims the benefit of priority under U.S.C. §119(e) of U.S. Provisional Application No. 61/340,997, filed on Mar. 25, 2010, the full disclosure of which is incorporated herein by reference.

### TECHNICAL FIELD

This invention relates generally to the field of dentistry, and more particularly, but not exclusively to extending a dental drill used for procedures such as dental implant.

### BACKGROUND

Dental implants are an increasingly popular dental restoration option for patients with missing teeth due to excessive decay to the tooth roots, bone or gum damage, or accidents causing physical displacement. Particularly, dental implants may provide a more permanent solution than other procedures such as a crown or a bridge supported by natural tooth roots. Furthermore, dental implants provide an alternative to dentures because they look natural and require less maintenance. Implants further provide a stronger biting surface and allow patients to resume their normal diets.

A dental implant procedure includes placing a root-form endosseous implant within the bone. The implant is typically a titanium post that appears similar to an actual tooth root. The bone of the jaw accepts and osseointegrates with the implant, thereafter, a crown may be placed on the implant. When placing dental implants, it is first necessary to create an opening for the dental implant using a pilot drill. The overall length of a typical such drill is 33 mm. On occasion, adjacent teeth may obstruct the head of the contra angle hand piece from properly accessing and drilling an opening of appropriate depth. In these instances, a fixed length extension is commonly used. An example length of these drill extenders is about 16 mm. However, the use of these extensions increases the overall length of the drill and can compromise accessing the appropriate location for drilling. What is needed is an improved extension device which allows customized lengthening of the drill to accommodate various patient anatomies.

### SUMMARY OF THE INVENTION

Described herein are devices, methods, and systems for extending the length of a dental drill.

In one aspect, an embodiment of an extender for a dental apparatus comprises a distal connecting portion, a proximal connecting portion, and an elongated portion disposed between the distal connecting portion and the proximal connecting portion. The distal connecting portion may be configured to connect to a dental drill bit or the proximal connecting portion and the proximal connecting portion may be configured to connect to a dental hand piece or the distal connecting portion.

In another aspect, the extender may be configured to be recessed within the dental hand piece when the proximal connecting portion is connected to the dental hand piece.

In yet another aspect, the extender may comprise a first opening disposed on the distal connecting portion, a second opening disposed on the proximal connecting portion, and a lumen disposed inbetween the first and second openings. Additionally, the extender may be configured to transmit a fluid from the dental hand piece to the dental drill bit.

In yet another aspect, the distal connecting portion may comprise a locking element configured to secure the extender with the dental drill bit or the proximal connecting portion of another extender. Furthermore, the proximal connecting portion may comprise a receiving element configured to receive a locking element, such as the locking element disposed on the distal connecting portion.

In still yet another aspect, the extender may be configured to be of various lengths, in one embodiment, the extender may be about 5 mm in length.

Also disclosed herein are various aspects of a dental drilling system. In one aspect, a dental drilling system comprises a dental hand piece comprising a head and a body, a dental drill bit, a first extender and a second extender. The first extender and the second extender each comprise a distal connecting portion, proximal connecting portion, and an elongated portion disposed inbetween the distal connecting portion and the proximal connecting portion. The distal connecting portion of the first extender may be configured to connect to the dental drill bit, the proximal connecting portion of the first extender may be configured to connect to the distal connecting portion of the second extender, and the proximal connecting portion of the second extender may be configured to connect to the dental hand piece.

In another aspect, the dental drilling system may further comprise an irrigation channel that connects the dental hand piece and the dental drill bit through the first and the second extenders.

This, and further aspects of the present embodiments are set forth herein.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1A illustrates one embodiment of a dental drilling system comprising a dental drill bit and a dental hand piece.

FIG. 1B illustrates one embodiment of a dental drilling system comprising a dental drill bit, a dental hand piece, and an extender.

FIGS. 2A-E illustrate various views of one embodiment of the extender.

FIG. 3 illustrates one embodiment where two extenders are connected end-to-end.

FIG. 4 illustrates one embodiment where two connected extenders are connected to a dental drill bit.

### DETAILED DESCRIPTION

Although the detailed description contains many specifics, these should not be construed as limiting the scope of the invention but merely as illustrating different examples and aspects of the invention. It should be appreciated that the scope of the invention includes other embodiments not discussed in herein. Various other modifications, changes and variations which will be apparent to those skilled in the art may be made in the arrangement, operation and details of the method and apparatus of the present invention disclosed herein without departing from the spirit and scope of the invention as described here.

When performing dentistry, it is often necessary for the operator to create and/or enlarge an opening within a patient's mouth. For example, an implant will require osteotomy to have a specific osteotomy depth determined by the manufacturer of the implant. Thus, it is first necessary to create an opening for the dental implant using a drill, such as a pilot drill. Embodiments of the present invention disclose devices, systems, and methods that enable customizable incremental extension of the dental drill to allow greater accessibility, control, and flexibility to access an operation site.

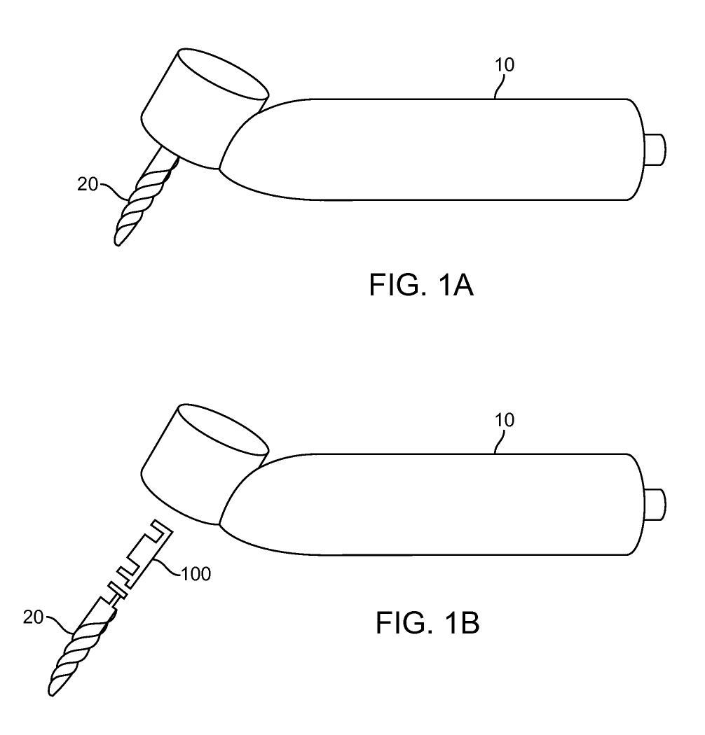

Referring now to FIG. 1, where a dental drilling system is shown. The system comprises a dental hand piece 10 and a dental drill bit 20. The system may be used by an operator to prepare an osteotomy, i.e., opening, in a mandibular or maxilla bone of a patient in preparation for placement of an implanted device such as a dental implant (not shown). The hand piece 10 may assume various configurations but typically the hand piece 10 comprises an elongated portion that allows the operator to manually maneuver the hand piece 10 and a head that is configured to receive the drill bit 20. The head is typically contoured at an angle to facilitate drill site access.

The hand piece 10 further comprises a motor (not shown) that is configured to drive or rotate the drill bit 20. The hand piece 10 may be connected to a power source (not shown), that provides power to the motor. Typically, the hand piece 10 operates around 400,000 rpm for high speed precision operations, although the hand piece 10 may operate at up to 800,000 rpm. Additionally a hand piece 10 may operate at a speed that is dictated by a micromotor which creates the momentum for applications requiring higher torque than a high-speed hand piece can deliver. Furthermore, the hand piece 10 may comprise various lumens or channels configured to deliver or transmit one or more treatment fluids such as saline or antibiotic from a fluid source to the drill bit 20.

The dental drill bit 20 is exemplarily shown as an elongated device that is driven by the hand piece 10 to create or enlarge an opening in a dental operation site. The drill bit 20 may comprise a shaft with a cutting or a reaming tip for creating an opening at an operation site, and a socket distal from the tip that is operably received in the hand piece 10. As seen in FIG. 1, the drill bit 20 may comprise helical grooves of various configurations to facilitate drilling. Furthermore, the drill bit 10 may comprise measurement markings (not shown) to help the operator to gauge the drilling depth.

As referred to herein, the drill bit 20 may be a pilot drill, needlepoint drill, implant drill, cutting bur, scoring bur or various configurations. Additionally, the drill bit 20 may be a bone bur, reamer, saw disc, trephine drill. Furthermore, it is contemplated that the drill bit 20 may be any drilling, cutting, bone harvesting, contouring, or retrieval device that may be operably received by the hand piece 20 and is configured to contact with or operate within a dental operation site.

The drill bit 20 may be constructed of various materials such as various metal or metal alloys including steel or tungsten carbide. Additionally, the drill bit 20 may be coated with various materials such as diamond. The drill bit 20 may be configured with various lengths, diameter, sizes, and shapes. The drill bit 20 may further comprise irrigation channels that are configured to deliver or transmit one or more treatment fluids such as saline or antibiotic from the hand piece 10 to the operation site.

In an exemplary dental implant operation, the operator may first administer local anesthetic or general anesthesia to the patient. Thereafter, the operation site where the dental implant will be placed on the jawbone is accessed by making incisions in the patient's gums to reveal the bone underneath. Thereafter, the operator may use a pilot drill bit attached to a dental hand piece as seen in FIG. 1 to create an opening on the operation site. The opening created by the pilot drill bit is typically too small to accommodate the implant. Instead, the opening provides the opportunity to evaluate the alignment and depth of the hole in which the dental implant will ultimately be placed.

Initially, the pilot drill bit may be used to create an opening about one third to one half of the length needed for the dental implant. Thereafter, the alignment of the opening may be evaluated using alignment pins to ensure the desired orientation of the opening has been achieved. After checking the initial positioning of the opening, the operator may resume drilling with the pilot drill bit wherein the opening depth is enlarged or deepened to accommodate the full length of the body of the dental implant. Thereafter, the operator may use a series of implant drills or bone drills, each of increasing diameter, to enlarge the opening to a final diameter that is capable of accommodating the implant that has been selected for placement.

In many circumstances, a patient's anatomy may obstruct, deny, or limit drilling access to the desired operation site and/or limits drilling to the appropriate depth. For example, adjacent teeth may obstruct access to the operation site and/or drilling, or the patient may have a small mouth that limits access to the operation site and/or drilling. In these instances, it may be necessary to extend the length of the drill to increase the reach, access and maneuverability of the drill.

Referring now to FIG. 1B, where a dental drill system comprising an embodiment of an extender is shown. The extender 100 is configured to connect to the dental drill bit 20 and connect to the dental hand piece 10, thereby extending the operating length or reach of the drill bit 20. As used herein, the term connect refers to joining, receiving, mating, attaching, coupling, marrying a portion of the extender 100 to another device such as a dental hand piece, a dental drill bit, another extender, or other apparatus.

It is envisioned that the extender 100 may be of any length. In one embodiment, the extender 100 may less than 16 mm. In another embodiment, the extender 100 may be less than 10 mm. In yet another embodiment, the extender 100 may be about 5 mm or less. In such embodiment, the extender 100 may be substantially recessed within the head of the hand piece 10. Such configuration may be advantageous since a significant increase to the overall length of the drill may compromise accessing the appropriate operation site for drilling, especially for patients with a small mouth.

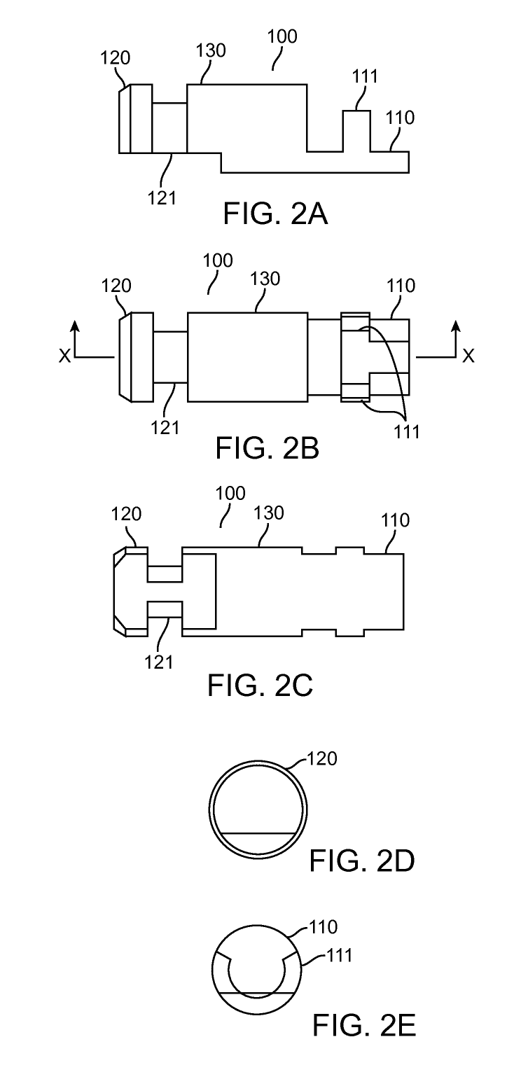

Referring now to FIGS. 2A-2E, where various perspective views of one embodiment of the extender are exemplarily shown. The extender 100 comprises a distal connecting portion 110 and a proximal connecting portion 120 with an elongated portion 130 disposed inbetween. The distal connecting portion 110 is configured to connect to a dental drill bit and the proximal portion 120 is configured to connect to a dental hand piece. In one embodiment, the distal connecting portion 110 is configured to connect to a standardized socket on the drill bit and the proximal connecting portion 120 is configured to connect to a standard dental hand piece. Preferably, the distal and the proximal connecting portions are configured to meets one or more standards for dental rotary instruments, such as any applicable ISO standards including ISO 1797-1:1992. Alternatively, the distal connecting portion 110 and the proximal connecting portion 120 may be configured to connect to a customized socket on a dental drill bit or a dental hand piece.

In one embodiment, the elongated portion 130 may be substantially cylindrical. The diameter of the elongated portion 130 may be configured to conform substantially to the diameter of the drill bit shaft, of which the extender 100 is configured to be connected with. In such an embodiment, the extender 100 and the shaft of the drill bit are configured to form a substantially continuous body. Alternatively, it is contemplated that the elongated portion 130 may assume various configurations, shapes, diameters, sizes, or dimensions.

Additionally and optionally, the elongated portion 130 may comprise one or more marking bands (not shown) that extend peripherally around the circumference of the elongated portion 130 to indicate one or more distances. In one embodiment, the marking bands may indicate the distance or length of the extension.

The distal connecting portion 110 may comprise a locking element 111 that is configured to substantially secure the extender 100 to another extender or to a drill bit once the drill bit is connected to the extender 100. The locking element 111 may be further configured to enable disconnecting or disengaging the extender from the drill bit through simple mechanical motion such as pushing the extender away from the drill bit. As seen in FIG. 2E, the locking element 111 may comprise two tines that extend in a substantially circular fashion following the circumference of the extender 100 with an opening inbetween for insertion or removal of the drill bit. The tines may be on the same plane such that by extending one or both tines, the two tines would connect to form a substantially circular shape. Alternatively, the two tines may be on different planes such that by extending the tines, it will result in two substantially circular shapes. Furthermore, it is contemplated that the locking element may comprise more than two tines on multiple planes.

The proximal connecting portion 120 may comprise a receiving element 121 that is configured to receive a locking element, such as that disposed within the head of the dental hand piece or on another extender. As seen in FIG. 2A, the receiving element 121 may comprise a recessed portion of the proximal connecting portion 120, wherein the diameter or dimension of the recessed portion is less than the rest of the proximal connecting portion 120. In such embodiment, the locking element, such as the one described above, may be fitted into the recess portion of the receiving element 121 and thus substantially securing the proximal connecting portion 120 with another device. It is further contemplated that the receiving element 121 may assume various configurations that are complementary or are configured to receive a locking element.

It is contemplated that the extender 100 may comprise a proximal opening (not shown) disposed on the proximal connecting portion 120, a distal opening (not shown) disposed on the distal connecting portion 110, and a lumen disposed within the elongated body 130 that connects the distal opening with the proximal opening. The distal opening is configured to substantially align with an opening on the dental drill bit and the proximal opening is configured to substantially align with an opening on the dental hand piece. The distal and proximal openings and the lumen inbetween may effectively serve as an irrigation channel that is configured to deliver or transmit one or more treatment fluids such as saline or antibiotics from the dental hand piece to the dental drill bit, where the treatment fluids may be dispense to the operation site through channels disposed on the drill bit.

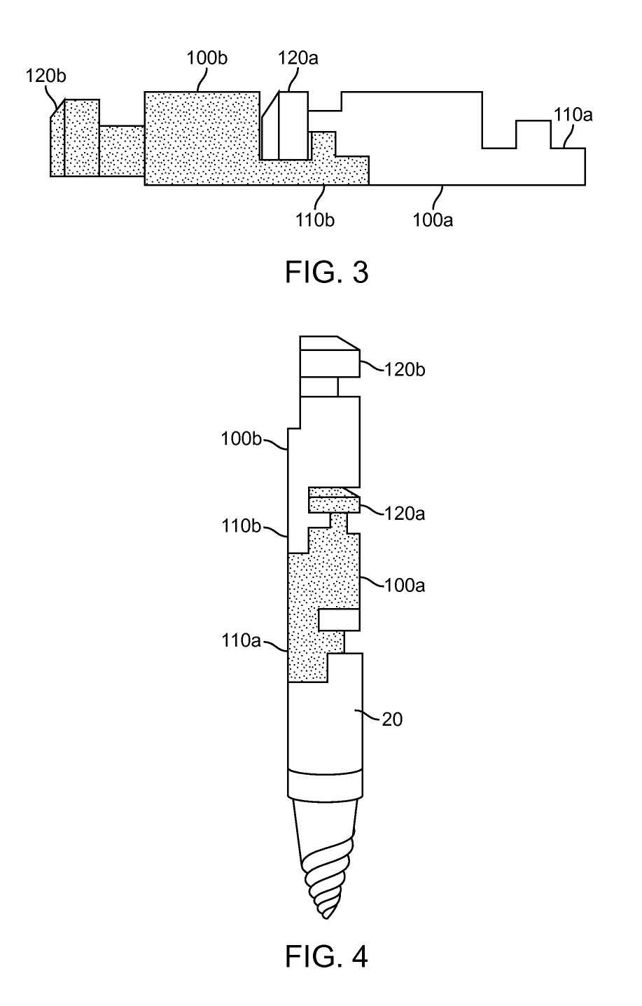

It is further contemplated that an embodiment of the extender may be connected to another extender to further increase the reach, access, and/or maneuverability of the drill to better accommodate a patient's anatomy. By using multiple extenders, the operator is afforded the flexibility to customize the desired length of the extension to the drill bit. Referring now to FIG. 3 and FIG. 4, where two extenders of the present embodiments in a connected configuration are shown. As seen in FIG. 3, the proximal connecting portion 120a of the first extender 100a may be connected to the distal connecting portion 110b of the second extender 100b. The locking element disposed on the distal connecting portion 110b of second extender 100b may be configured to be received by the receiving element 120a of the first extender 100a such that the two extenders may be substantially securely connected end-to-end.

The distal connecting portion 110a of the first extender 100a may be configured to connect to a dental drill bit 20 as seen in FIG. 4, and the proximal connecting portion 120b may be configured to connect to a dental hand piece (not shown). Alternatively, the proximal connecting portion 120b may be connected to a third extender in a similar fashion, such that the length of the extension may be further increased.

It is further contemplated that in an embodiment, where the first and the second extenders 100a and 100b each comprises distal and proximal openings with a lumen inbetween, the proximal opening of the first extender 100a may be configured to substantially align with the distal opening of the second extender 100b such that the first and the second extenders form a substantially continuous irrigation channel spanning two extenders. In such an embodiment, one or more treatment fluids such as saline or antibiotics may be delivered or transmitted through multiple extenders from the dental hand piece to the dental drill bit.

Although it has exemplarily shown in FIG. 3 and FIG. 4 that two extenders may be connected and used in tandem, it is contemplated that additional extenders may by used to further increase the length of the extension.

The various embodiments of the extender described above may be constructed of various materials such as steel or tungsten carbide, various metal or metal alloys, or any other material.

Although the various embodiments of the extender are described in relation with dental implant operations, it is envisioned that the embodiments of the extender described above may be used in various other dental applications.

While the above is a complete description of the preferred embodiments of the invention, various alternatives, modifications, and equivalents may be used. Therefore, the above description should not be taken as limiting the scope of the invention which is defined by the appended claims.

What is claimed is:

1. An extender for a dental apparatus, comprising:
a distal connecting portion;
a proximal connecting portion; and
an elongated portion disposed between the distal connecting portion and the proximal connecting portion;
wherein the distal connecting portion is configured to connect to a dental drill bit or the proximal connecting portion and wherein the proximal connecting portion is configured to connect to a dental hand piece or the distal connecting portion.

2. The extender of claim 1, wherein the extender is configured to recess within the dental hand piece when the proximal connecting portion is connected to the hand piece.

3. The extender of claim 1, further comprising a first opening disposed on the distal connecting portion, a second opening disposed on the proximal connecting portion, and a lumen disposed inbetween the first and second openings.

4. The extender of claim 3, wherein the extender is configured to transmit a fluid from the dental hand piece to the dental drill bit.

5. The extender of claim 1, wherein the distal connecting portion comprises a locking element configured to secure the extender with the dental drill bit or the proximal connecting portion.

6. The extender of claim 1, wherein the proximal connecting portion comprises a receiving element configured to receive a locking element.

7. The extender of claim 1, wherein the length of the extender is about 5 mm.

8. A dental drilling system, comprising:
a dental hand piece comprising a head and a body;
a first extender and a second extender; wherein the first extender and the second extender each comprises a distal connecting portion, proximal connecting portion, and an elongated portion disposed inbetween;
a dental drill bit;
wherein the distal connecting portion of the first extender is configured to connect to the dental drill bit, the proximal connecting portion of the first extender is configured to connect to the distal connecting portion of the second extender, and the distal connecting portion of the second extender is configured to connect to the dental hand piece.

9. The system of claim 8, further comprising an irrigation channel that connects the dental hand piece and the dental drill bit through the first and the second extenders.
